(19) United States
(12) Patent Application Publication
(10) Pub. No.: US 2007/0019768 A1
(43) Pub. Date: Jan. 25, 2007

(54) Sampling device and sampling method

(75) Inventors: Osamu Furukawa, Tokyo (JP); Shinichi Nakano, Tokyo (JP); Takashi Yoshida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/486,141

(22) Filed: Jul. 14, 2006

(30) Foreign Application Priority Data
Jul. 15, 2005 (JP) P. 2005-206355

(51) Int. Cl. H04L 7/00

(52) U.S. Cl. 375/355

(57) ABSTRACT

A sampling device for repetitive sampling a measured signal includes a measured signal sampling circuit for sampling the measured signal, a reference signal generating circuit for generating a reference signal having a predetermined frequency, a sampling circuit for sampling the reference signal generated by the reference signal generating circuit, and a frequency converting circuit for generating a strobe signal from a clock signal being synchronized with the measured signal, the strobe signal causing the sampling circuit and the measured signal sampling circuit to execute sampling.

This application claims foreign priority based on Japanese Patent application No. 2005-206355, filed Jul. 15, 2005, the content of which is incorporated herein by reference in its entirety.

### BACKGROUND OF THE INVENTION

1. Field of the Invention

This invention relates to a sampling device and a sampling method for repetitive sampling a measured signal, and more specifically to a sampling device and a sampling method capable of reproducing a waveform of the measured signal with high accuracy.

2. Description of the Related Art

The sampling device serves to repeatedly sample a measured signal produced from a device under test in, for example, a sampling oscilloscope. The sampling device is employed in sampling oscilloscopes as well as in a jitter analyzer under tests such as a time interval analyzer.

The sampling oscilloscope repeatedly samples the measured signal using shifted phases and reproduces its waveform on the basis of the phases. A related sampling oscilloscope samples a clock signal synchronized with the measured signal as phase information, computes the phase information of the clock signal on the basis of the amplitude information of the clock signal sampled and acquires the sampling timings of the measured signal on the basis of the phase information computed, thereby generating the waveform of the measured signal.

FIG. 6 is a view showing a configuration of the related sampling oscilloscope (for example, see JP-A-2003-66070 and JP-A-2003-130892). In FIG. 6, a device under test 10 outputs a measured signal and a clock signal synchronized with the measured signal (hereinafter referred to as a synchronized clock signal).

A sampling oscilloscope 20 includes sampling circuits 21 to 23, a low-pass filter circuit (hereinafter abbreviated as LPF (Low Pass Filter)) 24, a phase adjusting circuit 25, a time base calculator 26, and a strobe signal generating circuit 27. The sampling oscilloscope 20 is supplied with the measured signal and synchronized clock signal from the device under test 10.

The sampling circuit 21 is supplied with the measured signal from the device under test 10. The LPF 24 is supplied with the synchronized clock signal from the device under test 10. The phase adjusting circuit 25 is supplied with the signal filtered by the LPF 24. The sampling circuits 22 and 23 are supplied with the output from the phase adjusting circuit 25. The time base calculator 26 is supplied with the signals sampled by the sampling circuits 22 and 23. The strobe signal generating circuit 27 supplies a strobe signal to the sampling circuits 21 to 23.

An explanation will be given of the operation of the aforementioned sampling device.

In the sampling oscilloscope 20, the sampling circuit 21 and LPF 24 are supplied with the measured signal and the synchronized clock signal from the device under test 10, respectively. The LPF 24 reshapes the synchronized clock signal into a sine wave that is supplied to the phase adjusting circuit 25. The phase adjusting circuit 25 phase shifts the reshaped sine wave to output a quadrature cosine wave. The phase adjusting circuit 25 supplies the sine wave to the sampling circuit 22 and supplies the cosine wave to the sampling circuit 23.

The sampling circuits 21 to 23 simultaneously sample the inputted signals that are based on the same strobe signal from signal generating circuit 27 (respectively sampling the measured signal, sine wave and cosine wave).

The sampling results of the sampling circuits 22, 23 are supplied to the time base calculator 26. The time base calculator 26 computes the phase of the synchronized clock signal on the basis of the sampled values. Furthermore, since the sampling timing of sampling circuits 21 to 23 is the same, the sampling timing of the measured signal is acquired on the basis of the phase information computed.

Since the period of the strobe signal generated by the strobe signal generating circuit 27 is known, the time base computing means 26 applies the sampled value to the sine wave by, for example, the least squares method, and thereby estimates the frequency of the synchronized clock signal. The estimated frequency of the sine wave and the amplitude of the sampled value are compared, and the phase is then inversely referred to, thereby obtaining the phase of the synchronized clock signal when the sampling is executed. Furthermore, the sampling timing is acquired on the basis of the phase information thus acquired.

A waveform generator not shown in the figures generates the waveform of the measured signal on the basis of the amplitude of the measured signal from sampling circuit 21 and the sampling timings from time base calculator 26. The waveform generated is displayed on a display unit not shown in the figures.

Next, jitter will be explained. The jitter includes the jitter of the synchronized clock signal itself and the jitter generated by the strobe signal generating circuit 27. The jitter of the synchronized clock signal is detected by the samplings done by sampling circuits 22 and 23, in the form of phase changes in the sine wave and cosine wave. Thus, the time base information of a horizontal axis including the jitter of the synchronized clock signal is obtained. Likewise, the jitter of the synchronized clock signal causes jitter in the sampling timing of sampling circuit 21, thereby influencing the change in the amplitude information of a vertical axis. Namely, the jitter is included in both the horizontal axis and vertical axis so that the jitter of the synchronized clock signal is cancelled out, thereby providing the measurement result with the corrected jitter of the synchronized clock signal.

On the other hand, the jitter in the strobe signal generating circuit 27 influences the sampling in the sampling circuits 21 to 23. However, the sampling in the sampling circuits 21 to 23 is carried out at the same timing based on the same strobe signal. Therefore, the jitter of the strobe signal is cancelled out, thereby providing the measurement result with the corrected jitter of the strobe signal.

In this way, the measured signal and the clock signal synchronized therewith are simultaneously sampled, and the phase information is acquired from the amplitude of the synchronized clock signal and the sampling timing is acquired from the phase information acquired. Therefore, in order to acquire the exact sampling timing, the waveform of the synchronized clock signal must be estimated exactly.

However, the waveform quality of the synchronized clock signal differs for each device under test 10. If the synchronized clock signal contains waveform distortions, it becomes difficult for the time base calculator 26 to exactly estimate the waveform, thus leading to errors in the sampling timing.

In order to correct the waveform distortion of the synchronized clock signal, the LPF 24 removes the spurious components to extract the sine waveform. However, since the band of the synchronized clock signal is as broad as several GHz to several tens of GHz, a plurality of LPFs 24 with different cut-off frequencies need to be used.

Further, although the phase adjusting circuit 25 generates quadrature sine and cosine waves, since the band of the synchronized clock signal is very broad, it is difficult to keep the phase adjustment amount constant over the entire band. Namely, if the phase adjustment is 90° so that the sine wave and cosine wave are completely in quadrature to each other, the time base calculator 26 can acquire the exact sampling timing, thereby improving the measurement accuracy. However, since the phase adjustment amount is not constant, the measurement accuracy of the sampling timing is limited, thus leading to a problem that the sampling timing must be acquired while taking into consideration changes in the quantity of phase adjustment due to frequencies.

Further, as described above, since the band of the synchronized clock signal is very broad, design and manufacture of the sampling circuits 22 and 23 for sampling the synchronized clock signal requires advanced technology and results in high cost.

### SUMMARY OF THE INVENTION

The present invention has been made in view of the above circumstances, and provides a sampling device and a sampling method capable of reproducing a waveform of a measured signal with high accuracy.

In some implementations, a sampling device of the invention for repetitive sampling a measured signal, the sampling device comprising:

a measured signal sampling circuit for sampling the measured signal;

a reference signal generating circuit for generating a reference signal having a predetermined frequency;

a sampling circuit for sampling the reference signal generated by the reference signal generating circuit; and

a frequency converting circuit for generating a strobe signal from a clock signal being synchronized with the measured signal, the strobe signal causing the sampling circuit and the measured signal sampling circuit to execute sampling.

In some implementations, a sampling device of the invention for repetitive sampling a measured signal, the sampling device comprising:

a reference signal generating circuit for generating a reference signal having a predetermined frequency;

a first frequency converting circuit for generating a first strobe signal from a clock signal being synchronized with the measured signal;

a second frequency converting circuit for generating a second strobe signal from the clock signal, a frequency of the second strobe signal being different from that of the first strobe signal;

a measured signal sampling circuit for sampling the measured signal by using the first strobe signal;

a first sampling circuit for sampling a first reference signal by using the first strobe signal, the first reference signal being obtained from the reference signal generated by the reference signal generating circuit;

a second sampling circuit for sampling the first reference signal by using the second strobe signal:

a time base calculator for obtaining time base information of the measured signal sampling circuit on the basis of sampled values obtained by the first sampling circuit and the second sampling circuit; and

a waveform generator for obtaining a waveform of the measured signal on the basis of the time base information acquired by the time base calculator and sampled values obtained by the measured signal sampling circuit.

The sampling device of the invention further comprising:

a phase adjusting circuit for generating a second reference signal having a phase that is different from that of the reference signal generated by the reference signal generating circuit;

a third sampling circuit for sampling the second reference signal by using the first strobe signal, and for outputting sampled values to the time base calculator; and

a fourth sampling circuit for sampling the second reference signal by using the second strobe signal, and for outputting sampled values to the time base calculator,

wherein the time base calculator selects the sampled values being obtained by sampling a signal of which slew rate is high, thereby obtaining the time base information.

The sampling device of the invention, further comprising:

a phase adjusting circuit for generating the first reference signal and a second reference signal having a phase that is different from that of the first reference signal on the basis of the reference signal generated by the reference signal generating circuit, and outputting the first reference signal to the first sampling circuit and the second sampling circuit, the phase adjusting circuit being arranged between the reference signal generating circuit and the first and second sampling circuits;

a third sampling circuit for sampling the second reference signal by using the first strobe signal, and for outputting sampled values to the time base calculator;

a fourth sampling circuit for sampling the second reference signal by using the second strobe signal, and for outputting sampled values to the time base calculator,

wherein the time base calculator selects the sampled values being obtained,by sampling a signal of which slew rate is high, thereby obtaining the time base information.

In the sampling device of the invention, the phase adjusting circuit generates the second reference signal of which phase is in quadrature to that of the first reference signal.

In the sampling device of the invention, the first frequency converting circuit is a frequency synthesizer that uses a phase locked loop.

In the sampling device of the invention, the first frequency converting circuit generates the first strobe signal with a variable frequency.

In some implementations, a sampling method of the invention for repetitive sampling a measured signal and reproducing a waveform of the measured signal, the sampling method comprising:

generating a reference signal having a predetermined frequency;

generating a strobe signal from a clock signal being synchronized with the measured signal;

sampling the measured signal and the reference signal by using the strobe signal respectively;

obtaining time base information of the measured signal on the basis of a sampling result of the reference signal; and

reproducing the waveform of the measured signal on the basis of the obtained time base information and a sampling result of the measured signal.

This invention provides the following advantages.

In an embodiment of the present invention, the reference signal generating circuit generates a reference signal with a known frequency. The sampling circuit samples the reference signal using the strobe signal converted from the clock signal, thereby obtaining the sampling timings of the measured signal. Thus, without determining the relationship between the frequency or phase between the clock signal and the reference signal, although they are unknown, the exact sampling timing with corrected jitter can be acquired, thereby reproducing the waveform of the measured signal with high accuracy.

In another embodiment of the present invention, the reference signal generating circuit produces the reference signal with a known frequency. The first and second sampling circuits sample the reference signal using the first and second strobe signals converted from the clock signal respectively, thereby obtaining the sampling timings of the measured signal. Thus, without determining the relationship between the frequency or phase between the clock signal and the reference signal, although they are unknown, the exact sampling timing with corrected jitter can be acquired, thereby reproducing the waveform of the measured signal with high accuracy.

The phase adjusting circuit generates reference signals with different phases. The first through fourth sampling circuits each sample the reference signals with different phases. The time base calculator samples two kinds of signals and selects the sampled value with the higher slew rate, thereby obtaining the time base information. Thus, quantization errors in the sampling circuit that arise when the signal slew rate is too small can be reduced so that the exact sampling timings are obtained, thereby reproducing the waveform of the measured signal with high accuracy.

Since the first frequency converting circuit is a frequency synthesizer that uses the phase locked loop, the strobe signal with a highly stabilized frequency and low jitter can be outputted.

The first frequency converting circuit can vary the frequency of the first strobe signal so that even when the band of the clock signal is broad (several GHz to several tens of GHz), a suitable beat can be generated. Thus, the sampling can be carried out with the time resolution necessary for measurement and the number of sampling points needed to reproduce the waveform of the measured signal can be acquired in a short time.

In another embodiment of the present invention, a reference signal with a known frequency is produced; a strobe signal is generated on the basis of a clock signal synchronized with the measured signal; the measured signal and the reference signal are sampled using the strobe signal; time base information of the measured signal is acquired on the basis of a sampling result of the reference signal; and the waveform of the measured signal is reproduced on the basis of the time base information thus acquired and the sampling result of the measured signal. For this reason, without determining the relationship between the frequency or phase between the clock signal and the reference signal, although they are unknown, the exact sampling timing with corrected jitter can be acquired, thereby reproducing the waveform of the measured signal with high accuracy.

### BRIEF DESCRIPTION OF THE DRAWINGS

FIG. 1 is an arrangement view of a first embodiment of this invention.

FIG. 2 is a timing chart of sampling in an apparatus shown in FIG. 1.

FIG. 3 is a flowchart for explaining an operation of the apparatus shown in FIG. 1.

FIG. 4 is an arrangement view of a second embodiment of this invention.

FIG. 5 is a timing chart of sampling in an apparatus shown in FIG. 4.

FIG. 6 is an arrangement view of a related sampling oscilloscope.

### DESCRIPTION OF THE PREFERRED EMBODIMENTS

### First Embodiment

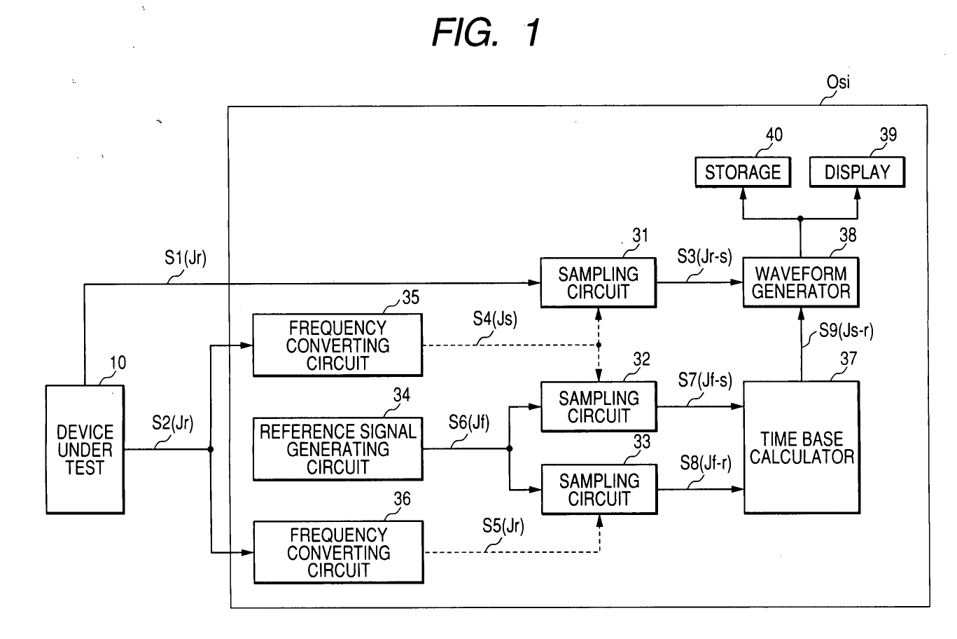

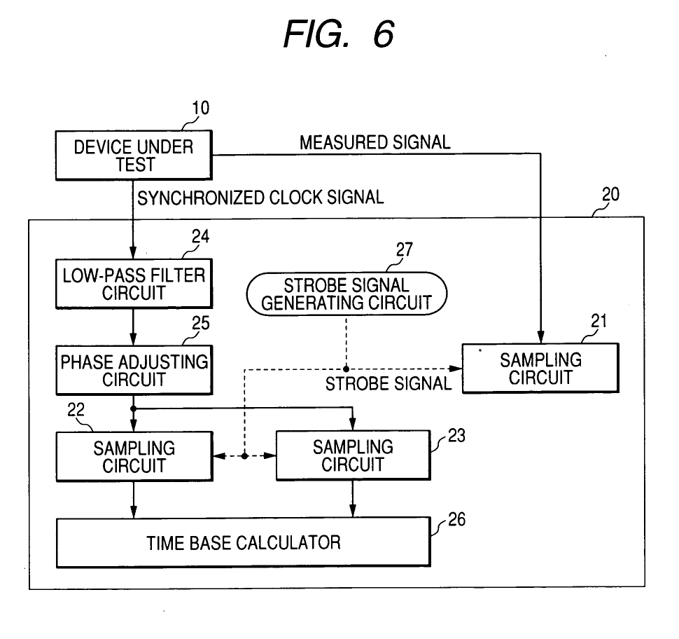

FIG. 1 is an arrangement view of a first embodiment of this invention. In FIG. 1, the reference numerals referring to similar parts in FIG. 6 will not be explained. In FIG. 1, in place of the oscilloscope 20, a sampling oscilloscope Osi is provided. The sampling oscilloscope Osi includes sampling circuits 31 to 33, a reference signal generating circuit 34, frequency converting circuits 35, 36, a time base calculator 37, a waveform generator 38, a display 39 and a storage 40.

The sampling oscilloscope Osi is supplied with a measured signal S1 and a synchronized clock signal S2 from device under test 10 to perform waveform analysis and to display the waveform of the measured signal. It is needless to say that the synchronized clock signal S2 is a clock signal synchronized with measured signal S1.

A sampling device includes sampling circuits 31 to 33, reference signal generating circuit 34, frequency converting circuits 35, 36, time base calculator 37 and waveform generator 38.

The measured signal sampling circuit 31 samples the measured signal S1 from the device under test 10 and supplies the sampling result (amplitude of the measured signal) to waveform generator 38 as a vertical axis information signal S3.

The first frequency converting circuit 35 frequency-converts a synchronized clock signal S2 from the device under test 10, thereby producing a first strobe signal S4 of which phase is synchronized with synchronized clock signal S2 but of which frequency differs from synchronized clock signal S2.

The second frequency converting circuit 36 frequency-converts a synchronized clock signal S2 from the device under test 10, thereby producing a second strobe signal S5 of which phase is synchronized with synchronized clock signal S2 but of which frequency differs from synchronized clock signal S2. It should be noted that the strobe signals S4 and S5 have different frequencies.

The first frequency converting circuit 35 may be, for example, a frequency synthesizer using a phase locked loop, which refers to synchronous signal S2 when it creates the signal with a differing frequency. As another example, the frequency converting circuit 35 may be a frequency mixer (otherwise known as a mixer) including a local oscillator, which creates a signal with a “down-converted” frequency via the local oscillator synchronous with the synchronized clock signal S2.

On the other hand, the second frequency converting circuit 36 may be, for example, a pre-scaler or a frequency divider.

The reference signal generating circuit 34 may be, for example, an oscillator with a narrow band of 5 GHz, which outputs a reference signal S6 with a known frequency and with little waveform distortion and high stability. The output waveform is not limited to a sine wave but may be a waveform of which phase corresponding to the continuous amplitude is uniquely determined such as a sawtooth wave.

The first and second sampling circuits 32, 33 sample the reference signal S6 from the reference signal generating circuit 34 and supply signals S7, S8 which correspond to the sampling results to the time base calculator 37.

The measured signal sampling circuit 31 and the first sampling circuit 32 are supplied with the timing of sampling by a strobe signal S4 from the frequency converting circuit 35, thereby executes the sampling.

The second sampling circuit 33 is supplied with the timing of sampling by a strobe signal S5 from frequency converting circuit 36, thereby executing the sampling.

Furthermore, the strobe signal S4 from the frequency converting circuit 35 is only slightly (for example, 9999/10000) shifted from the “down-converted” frequency from synchronized clock signal S2. Using this strobe signal S4, the measured signal sampling circuit 31 samples the measured signal sequentially, namely in a sequential sampling system.

The sampling circuits 31 to 33 may be, for example, a sampler, or an analog-digital converter with necessary and sufficient accuracy for measured signal S1 and reference signal S6, or a frequency mixer (mixer).

The time base calculator 37 is supplied with referring signals S7, S8 from sampling circuits 32, 33. The time base calculator 37 acquires the sampling phase of the synchronized clock signal S2 based on referring signals S7, S8, computes the sampling timing (time interval) based on the phase acquired, and supplies the calculated time base information to the waveform generator 38 as a horizontal axis (time base) information signal S9.

The waveform generator 38 creates the waveform of the measured signal S1 based on vertical axis information signal S3 and horizontal axis information signal S9. The waveform thus generated is displayed on the display 39, or stored or saved in the storage 40 in an appropriate format.

The time base calculator 37 and waveform generator 38 may be, for example, a computer system with a CPU (Central Processing Unit) or a signal processing system provided with a DSP (Digital Signal Processor). They may be either hardware or software.

The display 39 may be, for example, a CRT (Cathode Ray Tube), LCD (Liquid Crystal Display), organic EL (Electro luminescence) display, plasma display or an electronic tube.

Furthermore, the storage 40 may be, for example, a pen recorder, HD (Hard Disk), CD (Compact Disk), DVD (Digital Versatile Disk), FD (Floppy (Trade Name) Disk), or USB memory.

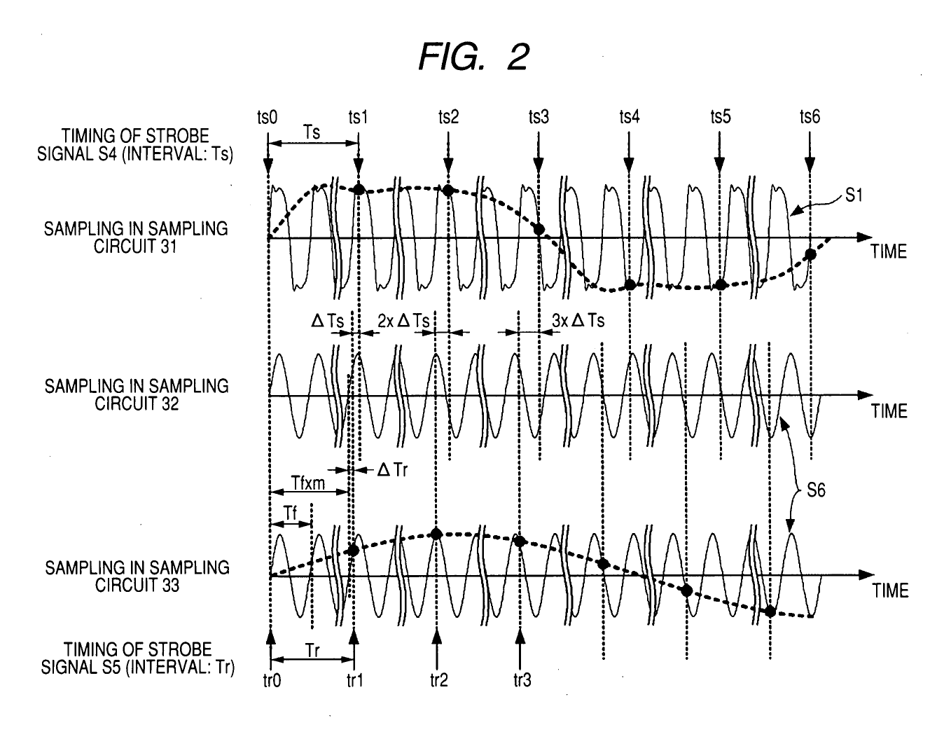

First, by referring to FIG. 2, an explanation will be given of the theory of sampling and reproducing the waveform of the measured signal S1 in the device shown in FIG. 1. FIG. 2 is a view showing sampling timings, and reproductions of the waveforms of the measured signal S1 and reference signal S6 in the device shown in FIG. 1. In FIG. 2, the horizontal axis represents time, whereas the vertical axis represents the amplitude of measured signal S1 and reference signal S6.

Timings ts0 to ts6 (sampling interval Ts) represent timings of sampling using the strobe signal S4. Timings tr0 to tr3 (sampling interval Tr) represent timings for sampling using strobe signal S5. It should be noted that Tr≠Ts and ΔTs=Ts−Tr. It is needless to say that sampling is executed repeatedly after ts6 and tr3, but this is not shown.

Assuming that the one period of the reference signal S6 is Tf and the period nearest to the interval Tr within a range not exceeding the interval Tr of the strobe signal S5 is Tf×m (where m is an integer), ΔTr=Tr−Tf×m.

The timings ts0 and tr0 are set to be the same time. For simplicity of explanation, the timing ts0 is set at the zero crossing point (the point where the amplitude shifts from minus to plus) of each of the measured signal S1 and the reference signal S6.

Now, assuming that the timing ts0 is the reference timing, the time interval between the timing ts1 to ts6 of the strobe signal S4, and the strobe signal tr1 to tr3 divided from the synchronized clock signal S2 is ΔTs, 2×ΔTs, 3×ΔTs, . . . .

The measured signal sampling circuit 31 samples the measured signal S1 with a displacement of ΔTs relative to the phase thereof, i.e. divisionally for each ΔTs. Therefore, by connecting the sampling points of the measured signal S1 (black points on measured signal S1 in FIG. 2), the waveform of the original measured signal S1 is reproduced. Likewise, since the reference signal S6 is shifted from the strobe signal S5 by its period, by connecting the sampling points of reference signal S6 (black points on the reference signal S6 in FIG. 2), the waveform of the original reference signal S6 is reproduced.

The displacement of ΔTs relative to the phase of the measured signal S1 corresponds to the actual time needed to reproduce the measured signal S1. Specifically, if ΔTs is increased, the time interval between the sampling points of the reproduced waveform becomes coarser. If ΔTs is reduced, the time interval becomes finer. Thus, ΔTs represents the time resolution of the measured signal sampling circuit 31. It should be noted that ΔTs can be set at a desired time difference ΔTs by the frequency converting circuit 35. Likewise, as seen from FIG. 2, the time resolution of the first sampling circuit 32 is ΔTs+ΔTr. The time resolution of the second sampling circuit 33 is ΔTr.

Next, the operation of the sampling device as described above will be explained.

The measured signal sampling circuit 31 is supplied with the measured signal S1 from the device under test 10, and the frequency converting circuits 35, 36 are supplied with the synchronized clock signal S2. The reference signal generating circuit 34 supplies the reference signal S6 to the sampling circuits 32, 33.

The first frequency converting circuit 35 supplies, to the sampling circuits 31, 32, the strobe signal S4 whose frequency is lower than (for example, by about 1/1000) and slightly different by ΔTs from that of the synchronized clock signal S2.

As described above, the strobe signal S4 is slightly shifted in frequency by ΔTs from the simply divided waveform of synchronized clock signal S2, but is in a predetermined phase relationship. A frame is the data during the one period from when the zero crossing points of strobe signal S4 and synchronized clock signal S2 match with each other to when they match with each other again. The timing when they match is referred to a head of the frame. The head of the frame may be set at the reference timing ts0.

On the other hand, the second frequency converting circuit 36 supplies the strobe signal S5 to the second sampling circuit 33. A frequency of the strobe signal S5 is obtained by dividing the synchronized clock signal S2 by a certain value, for example such as 1000.

The measured signal sampling circuit 31 samples the measured signal S1 at each of the timings ts0 to ts6 on the basis of strobe signal S4, and supplies the sampling result to the waveform generator 38 as vertical axis information signal S3.

The first sampling circuit 32 samples the reference signal S6 at each of the timings ts0 to ts6 using the strobe signal S4, and supplies the sampling result to the time base calculator 37 as the referring signal S7.

The second sampling circuit 33 samples the reference signal S6 at each of the timings tr0 to tr3 using the strobe signal S5, and supplies the sampling result to the time base calculator 37 as the referring signal S8.

The time base calculator 37 computes the resolution ΔTs for each of the sampling timings ts0 to ts6 from the referring signals S7 and S8, which is then supplied to the waveform generator 38. The operation of the time base calculator 37 will be explained in detail later.

Further, the waveform generator 38 creates/reproduces the waveform of the measured signal S1 based on the amplitude of the vertical axis information signal S3 from the measured signal sampling circuit 31 and the sampling resolution ΔTs of the horizontal axis information signal S9 from the time base calculator 37, which is displayed on the display 39 or stored in the storage 40.

Next, the jitter will be explained.

The jitter contains the jitter (hereinafter referred to as “Jr”) of the synchronized clock signal S2 itself that is externally supplied to the oscilloscope Osi and the jitter (hereinafter referred to as “Jf”)of the reference signal S6 produced by-the reference signal generating circuit 34.

The jitter Jr is transmitted as the phase fluctuation of the measured signal S1 to which it is synchronized to the vertical axis information signal S3 produced from the measured signal sampling circuit 31.

The jitter Jr of the synchronized clock signal S2 is transmitted to the strobe signal S4 through the first frequency converting circuit 35. However, this is the jitter containing only the frequency component that has been limited by the band of the first frequency converting circuit 35. Thus, since the jitter of the strobe signal S4 is different from Jr, it will be hereinafter referred to as Js. It is needless to say that Js contains a partial jitter component of Jr. Furthermore, since the measured signal sampling circuit 31 carries out the sampling using strobe signal S4, Js is transmitted to the amplitude of the vertical axis information signal S3 as fluctuations in the sampling timing in the measured signal sampling circuit 31.

However, if the measured signal sampling circuit 31 samples the measured signal S1 having the phase fluctuation of Jr using a strobe signal S4 that has the same phase fluctuation (i.e. where no jitter occurs in the first frequency converting circuit 35), both jitters Jr are cancelled out by each other and do not influence the sampling. Thus, if the measured signal sampling circuit 31 samples the measured signal S1 containing Jr using the strobe signal S4 containing Js, they jitters cancel each other so that the jitter of the vertical axis information signal is hereinafter referred to as Jr−s. The sign of “minus” does not mean mathematical subtraction, but conceptually represents the difference between the jitters (Jr and Js).

Jitter Jf is transmitted to referring signals S7, S8 as phase fluctuation of the sampled values in both of the sampling circuits 32, 33. However, sampling circuits 32, 33 carry out the sampling using the strobe signal S4 containing Js and the strobe signal S5 containing Jr, respectively.

Thus, Js is transmitted to referring signal S7 as fluctuations in the sampling timing in the first sampling circuit 32. As described above, since Js acts so as to cancel Jf, the jitter of referring signal S7 will be hereinafter referred to as Jf−s. The meaning of the minus sign is the same as described above. The jitter Jf−s is transmitted to the horizontal axis information signal S9 for the purpose of correcting the jitter Js of the strobe signal S4.

On the other hand, Jr is transmitted to strobe signal S5 via frequency converting circuit 36 and further transmitted to referring signal S8 as fluctuations in the sampling timing in the second sampling circuit 33. As described above, since Jr acts so as to cancel Jf, the jitter of the referring signal S8 will be hereinafter referred to as Jf−r. Again, the meaning of the minus sign is the same as above. The jitter Jf−r is transmitted to the horizontal axis information signal S9 for the purpose of correcting the jitter Jr of synchronized clock signal S2.

The jitter Jf is cancelled when the time base calculator 37 computes the differences between Jf−r and Jf−s. When the difference between referring signals S7 and S8 is acquired, the amplitude absolute value of reference signal S6 becomes zero. Therefore, only the jitter component Js−r or Jr−s of strobe signals S4, S5 is extracted. The meaning of the minus sign is the same as described above. Depending on whether the computation Js−r or Jr−s is used as the correcting method, the waveform correction process that is performed by waveform generator 38 is changed.

The waveform generator 38 combines the vertical axis information signal S3 containing the fluctuation Jr−s due to Jr and Js, with the horizontal axis information signal S9 containing the phase fluctuation Js−r or Jr−s due to Jr and Js, thereby canceling the influence of jitter for correction. Thus, the exact sampling timings ts0 to ts6 can be acquired.

As described above, in FIG. 1, the reference signal generating circuit 34, sampling circuits 32, 33 and time base calculator 37 acquire the corrected quantity (Js−r or Jr−s) of the jitter.

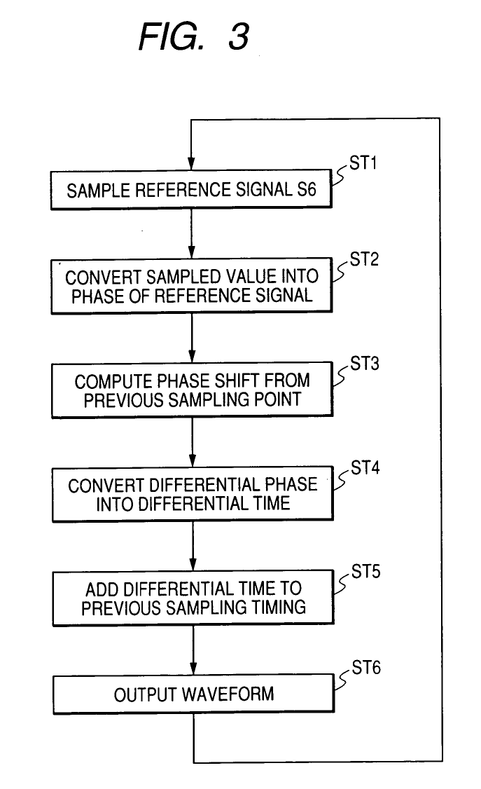

Referring to the flowchart of FIG. 3, an explanation will be given of the operation of the sampling circuits 32, 33, time base calculator 37 and waveform generator 38. Now, it is assumed that the reference signal generated from the reference signal generating circuit 34 is a sine wave with a known frequency and little waveform distortion.

The sampling circuits 32, 33 sample the reference signal and supply the referring signals S7, S8 to the time base calculator 37 (ST1).

The time base calculator 37 converts the sampled values of referring signals S7, S8 into the phase of reference signal S6. For example, if the reference signal S6 is a sine wave, it is acquired from the inverse trigonometric function (ST2).

Next, the time base calculator 37 acquires the shift of the phase of the sampling point acquired in step ST2 from the sampling point in the previous sampling. Incidentally, the previous sampling point is either the sampling timing ts0 at the head of the measured frame or the exact sampling timings ts1 to ts6 with the corrected jitter. Therefore, the phase shift therefrom contains the jitter at the present sampling point (ST3).

Further, the time base calculator 37 computes the difference between the phase shift obtained from the referring signal S7 and the phase shift obtained from the referring signal S8 and then converts a differential phase into a differential time (time base information) which is subsequently supplied to the waveform generator 38. This differential time contains the jitter component Js−r or Jr−s and also the difference between the sampling intervals of the strobe signals S4, S5, Ts−Tr, i.e. ΔTs in FIG. 2 (ST4).

The waveform generator 37 adds the differential time computed in step ST4 to the previous sampling timing, and merges the result with the amplitude of the vertical axis information signal S3 from the measured signal sampling circuit 31. Thus, any jitter at the present sampling point is eliminated, thereby correcting the present sampling point into the exact sampling timing (ST5).

Further, the waveform generator 38 supplies the waveform reproduced at the sampling tiring corrected in step ST5 to the display 39 or storage 40 (ST6).

In this way, the reference signal generating circuit 34 generates the reference signal S6 with a known frequency and amplitude and with little waveform distortion. The sampling circuits 35, 36 sample the reference signal S6 using the strobe signals S4, S5 converted from the synchronized clock signal S2, thereby obtaining the sampling timings of the measured signal S1. Thus, the following advantages (1) to (4) are obtained.
(1) Without obtaining the relationship in the frequency or phase between the synchronized clock signal S2 and the reference signal S6, as they are unknown, the exact sampling timings with corrected jitter can be acquired, thereby allowing reproduction of the waveform of the measured signal with high accuracy.
(2) Since reference signal S6 of the reference signal generating circuit 34 is known, it is not necessary to estimate the waveform of the synchronized clock signal for acquiring its phase as in the device as shown in FIG. 6. Therefore, it is not necessary to exactly acquire the frequency and such of the synchronized clock signal. Thus, the load for the time base calculator 37 is reduced, the waveform can be reproduced at a high speed.
(3) Since the reference signal S6 from the reference signal generating circuit 34 is known, it is not necessary to provide a plurality of LPFs 24 for circuit switching unlike the device shown in FIG. 6. Thus, it is not necessary to change the circuit configuration of the sampling device according to the synchronized clock signal S2, thus simplifying the circuit configuration.
(4) The band of the reference signal generating circuit 34 can be realized by a narrow band oscillator with e.g. about 5 GHz. Therefore, unlike the device shown in FIG. 6, it is not necessary to set the band of the sampling circuits 32, 33 in a broadband. Thus, the reference signal generating circuit 34 and sampling circuits 32, 33 can be manufactured at low cost. In addition, the technical difficulty of the design of strobe signals S4, S5 can be reduced. Accordingly, the technical difficulty of design and manufacture of the sampling device can be reduced so that the sampling device can be manufactured at low cost.

Furthermore, the first frequency converting circuit 35 creates the strobe signal S4 for sampling the measured signal S1. In this case, since the frequency conversion is carried out by the synthesizer using a phase locked loop, the strobe signal S4 with a stabilized frequency and with less jitter can be obtained. Thus, as compared with the ramp waveform generating circuit combined with a programmable delay circuit or the startable oscillating circuit, as disclosed in JP-A-2003-66070, the sampling timings with high accuracy can be generated.

Further, the first frequency converting circuit 35 carries out the frequency conversion by frequency synthesizer using not the delay circuit but the PLL so as to provide a desired interval ΔTs. Therefore, the sampling points can be collected quickly and surely.

The time base calculator 37 periodically sets the head of the measured frame at the reference timing by detecting the timing when the synchronized clock signal S2 and the strobe signal S4 are in phase with each other. Therefore, the computing accuracy of the horizontal axis information signal S9 can be kept continuously. Further, since the phases can be acquired by simple computation from the reference signal S6 with high quality, the horizontal information signal S9 with high accuracy can be obtained. In addition, unlike the device shown in FIG. 6, any computation such as fitting is not required, thereby greatly reducing the load of computation processing.

### Second Embodiment

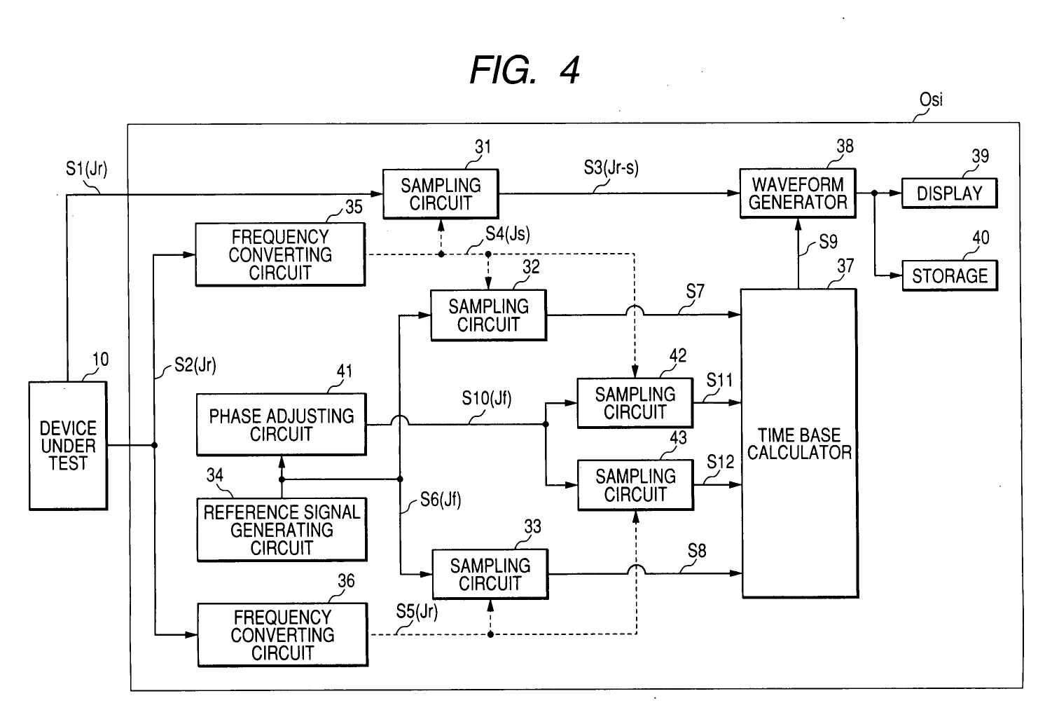

FIG. 4 is an arrangement view of a second embodiment of this invention. In FIG. 4, reference numerals referring to like parts in FIG. 1 will not be explained. In FIG. 4, newly provided are a phase adjusting circuit 41, a third sampling circuit 42 and a fourth sampling circuit 43.

The phase adjusting circuit 41 creates, on the basis of the reference signal S6 from the reference signal generating circuit 34, the second reference signal S10 which is differing in phase (e.g. quadrature in phase) from the reference signal S6.

The third sampling circuit 42 samples the reference signal S10 from the phase adjusting circuit 41 using the first strobe signal S4 supplied from the first frequency converting circuit 35, and supplies the sampling result to the time base calculator 37 as a referring signal S11.

The fourth sampling circuit 43 samples the reference signal S10 from the phase adjusting circuit 41 using the second strobe signal S5 supplied from the second frequency converting circuit 36, and supplies the sampling result to the time base calculator 37 as a referring signal S12.

The operation of such a device is substantially the same as that of the device shown in FIG. 1 and only the differences between the devices will be explained.

The phase adjusting circuit 41 phase-adjusts the reference signal S6 from the reference signal generating circuit 34 into the reference signal S10 that is in quadrature to the reference signal S6. In this case, if the reference signal S6 is a sine wave, a cosine wave phase-delayed by 90° is supplied to the sampling circuits 42, 43.

The third sampling circuit 42 executes the sampling of the cosine-wave reference signal S10 by using the strobe signal S4 and supplies the sampling result to the time base calculator 37. Namely, the sine-wave reference signal S6 and the cosine-wave reference signal S10 are simultaneously sampled by the sampling circuits 32 and 42 respectively, based on strobe signal S4.

The fourth sampling circuit 43 executes the sampling of the cosine-wave reference signal S10 by using the strobe signal S5 and supplies the sampling result to the time base calculator 37. Namely, the sine-wave reference signal S6 and the cosine-wave reference signal S10 are simultaneously sampled by the sampling circuits 33 and 43, respectively based on strobe signal S5.

The time base calculator 37 selects either one set of a set of the referring signals S7, S8 sampled from the sine-wave reference signal S6 or a set of the referring signals S11, S12 sampled from the cosine-wave reference signal S10, and computes the sampling phase of reference signal S6 or reference signal S10, thereby producing the horizontal information signal S9 employed for the sampling timing.

Namely, for both the sine wave and cosine wave, the slew rate is so small in the vicinity of their maximum value or minimum value of the amplitude such that the phase cannot be accurately acquired from the amplitude. For this reason, the set of the sampling points with a higher slew rate can be selected.

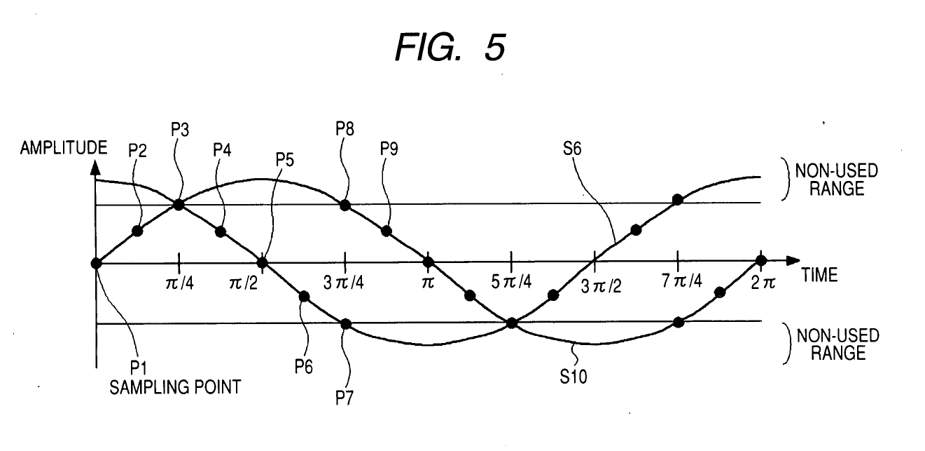

Now referring to FIG. 5, the concrete manner of sampling will be explained. FIG. 5 is a timing chart of sampling the reference signal s S6, S10. In FIG. 5, the horizontal axis represents time, whereas the vertical axis represents amplitude. Assuming that the point where the sine-wave reference signal S6 zero-crosses is set as 0, one period is illustrated. It should be noted that the sampling is carried out for each π/8.

The time base calculator 37 does not select the sampling points included in a non-used range but rather the sampling points with a high signal slew rate. The sampling points P1 to P3 select the sampled values obtained from the reference signal S10, the sampling points P4 to P7 select the sampled values obtained from the reference signal S6 and the sampling point P9 selects the sampled value obtained from the reference signal S10.

In an ideal quadrature state, i.e. where phases are shifted by 90° (π/2), if the sine wave with the initial phase of zero and the cosine wave with the initial phase of 900 (π/2) are sampled, by switching between the reference signals S6 and S10 that are selected at π/4, 3π/4, 5π/4 and 7π/4, the state with a higher signal slew rate can be kept.

It should be noted that at the sampling point P3, the sampling value of the other reference signal S10 may be employed, and the sampling point P8 may be substituted for sampling point P7.

In this way, the phase adjusting circuit 41 creates the reference signal S10 in quadrature to the reference signal S6 from the reference signal generating circuit 34. The sampling circuits 32, 33 sample the sine-wave reference signal S6, whereas the sampling circuits 42, 43 sample the cosine-wave reference signal S10. Furthermore, the time base calculator 37 selects the sampling points P1 to P9 with the higher slew rate to create the horizontal axis information signal S9. Thus, the following advantages can be provided.
(1) Where the output frequency of the reference signal generating circuit 34 is generating beat for the frequency of is the synchronized clock signal S2, the phase of the sine wave to be sampled is gradually shifted so that the gradient of the signal, i.e. slew rate thereof differs at sampling points. As described above, the signal slew rate of the sine wave (cosine wave) becomes smaller in the vicinity of the maximum or minimum amplitude. As a result, minute changes in the amplitude are buried in the quantization error in the sampling circuits 32, 33, 42, 43 so that they are not detected, thereby producing measurement error. However, by simultaneously sampling not only the sine wave but also the cosine wave in quadrature thereto and selecting either one of the signals with the higher slew rate, the phase measuring performance can be improved and the exact sampling timings can be generated, thereby reproducing the waveform with high accuracy.
(2) the frequency of the strobe signal S4 divided from the synchronized clock signal S2 with an unknown frequency is a multiple of the reference signal S6, the reference signals S6, S10 will be sampled with the same phase. However, the maximum signal slew rate is not always given at this phase, thereby leading to a limitation in performance. Specifically, in the non-used range shown in FIG. 5, if the reference signal S6 is always sampled, the measurement performance is greatly inferior to that in the sampling points P1 to P9 which have high signal slew rates. However, by simultaneously sampling not only the sine wave but also the cosine wave in quadrature thereto and selecting either one of the signal with the higher signal slew rate, the phase measuring performance can be improved and more exact sampling timings can be generated, thereby reproducing the waveform with high accuracy.

Further, since the phase adjusting circuit 41 creates the reference signal S10 on the basis of the reference signal S6 with a known frequency supplied from the reference signal generating circuit 34, the phase delay quantity by the phase adjusting circuit 41 can be made constant. Thus, the correction for each frequency of the reference signal S6 in the time base calculator 37 is not required, thereby facilitating the computation.

Meanwhile, in the device shown in FIG. 6, the frequency of the synchronized signal supplied to the phase adjusting circuit 25 is not constant. Therefore, it is difficult to adjust the adjusted quantity of the phase by 90° and consequently difficult to obtain the optimum performance on the other hand, in the device shown in FIG. 4, the phase adjusting circuit 41 creates the reference signal S10 on the basis of the reference signal S6 with a known frequency supplied from the reference signal generating circuit 34. Therefore, the phase adjusting circuit 41 can adjust the phase according to known frequency, thereby generating a reference signal S10 which is always out of phase by 90° from, i.e. completely in quadrature to reference signal S6. Thus, the exact sampling timings can be generated, thereby reproducing the waveform with high accuracy.

It should be noted that this invention should not be limited to the embodiments described above, but can be realized as follows.

In the device shown in FIGS. 1 and 4, this invention was applied to the sampling oscilloscope Osi. However, this invention may be applied to other measuring instruments, for example a jitter analyzer such as a time interval analyzer.

In the device shown in FIGS. 1 and 4, the measured signal S1 and synchronous clock signal S2 produced from device under test 10 may be either an electric signal or an optical signal. The output signal from the frequency converting circuits 35, 36 and the input/output signal of the sampling circuits 31 to 33, 42 and 43 maybe also either an electric signal or an optical signal according to the pertinent signal. The signal may also be based on a medium other than electricity or light.

In the device shown in FIGS. 1 and 4, the first frequency converting circuit 35 may finely adjust the frequency of strobe signal S4 in order to change the sampling interval Ts. For example, where the frequency of the synchronized clock signal S2 is a multiple of the strobe signal S4, the measured signal S1 is sampled at only the same phase. Therefore, in such a case, a sufficient number of sampling points can be not acquired over one period of the measured signal S1.

In order to obviate such inconvenience, the frequency converting device 35 may finely adjust the frequency of the strobe signal S4 to be outputted so that instead of being multiples of each other, the relationship is such that it generates a slight beat between the frequency of the synchronized clock signal S2 and that of the strobe signal S4. Thus, the phases in sampling the measured signal S1 can be selected evenly so that a sufficient number of sampling points can be obtained over one period of the measured signal S1. Further, by appropriately adjusting the beat, as compared with the case with no adjustment, the time taken to acquire a sufficient number of sampling points can be greatly shortened, thereby allowing the measurement to be performed at a high speed.

Now, since the frequency of the synchronized clock signal S2 is unknown, it is also unknown whether or not the strobe signal S4 has a frequency that is a multiple thereof. In this case, a frequency of strobe signal S4 that is definitely not a multiple of the frequency may be selected. Further, it is not necessary to acquire the exact frequency of the synchronized clock signal S2. For example, where the first frequency converting circuit 35 is constructed of the frequency synthesizer using the phase locked loop, the phase locked loop may be set on the basis of an approximate frequency. It is needless to say that the relationship of the frequency or phase between the synchronized clock signal in the frequency converting circuit 35 and reference signal S6 may be unknown.

In the device shown in FIG. 4, the sampling circuits 32, 33 sampled the reference signal S6 supplied from the reference signal generating circuit 34. However, the phase adjusting circuit 41 may create the first and second reference signals in quadrature to each other on the basis of the reference signal S6 supplied from the reference signal generating circuit 34 so that the first reference signal is sent to the sampling circuits 32, 33 and the second reference signal is sent to the sampling circuits 42, 43.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A sampling device for repetitive sampling a measured signal, the sampling device comprising:
a measured signal sampling circuit for sampling the measured signal;
a reference signal generating circuit for generating a reference signal having a predetermined frequency;
a sampling circuit for sampling the reference signal generated by the reference signal generating circuit; and
a frequency converting circuit for generating a strobe signal from a clock signal being synchronized with the measured signal, the strobe signal causing the-sampling circuit and the measured signal sampling circuit to execute sampling.

2. A sampling device for repetitive sampling a measured signal, the sampling device comprising:
a reference signal generating circuit for generating a reference signal having a predetermined frequency;
a first frequency converting circuit for generating a first strobe signal from a clock signal being synchronized with the measured signal;
a second frequency converting circuit for generating a second strobe signal from the clock signal, a frequency of the second strobe signal being different from that of the first strobe signal;
a measured signal sampling circuit for sampling the measured signal by using the first strobe signal;
a first sampling circuit for sampling a first reference signal by using the first strobe signal, the first reference signal being obtained from the reference signal generated by the reference signal generating circuit;
a second sampling circuit for sampling the first reference signal by using the second strobe signal;
a time base calculator for obtaining time base information of the measured signal sampling circuit on the basis of sampled values obtained by the first sampling circuit and the second sampling circuit; and
a waveform generator for obtaining a waveform of the measured signal on the basis of the time base information acquired by the time base calculator and sampled values obtained by the measured signal sampling circuit.

3. The sampling device according to claim 2, further comprising:
a phase adjusting circuit for generating a second reference signal having a phase that is different from that of the reference signal generated by the reference signal generating circuit;
a third sampling circuit for sampling the second reference signal by using the first strobe signal, and for outputting sampled values to the time base calculator; and
a fourth sampling circuit for sampling the second reference signal by using the second strobe signal, and for outputting sampled values to the time base calculator,
wherein the time base calculator selects the sampled values being obtained by sampling a signal of which slew rate is high, thereby obtaining the time base information.

4. The sampling device according to claim 2, further comprising:
a phase adjusting circuit for generating the first reference signal and a second reference signal having a phase that is different from that of the first reference signal on the basis of the reference signal generated by the reference signal generating circuit, and outputting the first reference signal to the first sampling circuit and the second sampling circuit, the phase adjusting circuit being arranged between the reference signal generating circuit and the first and second sampling circuits;
a third sampling circuit for sampling the second reference signal by using the first strobe signal, and for outputting sampled values to the time base calculator;
a fourth sampling circuit for sampling the second reference signal by using the second strobe signal, and for outputting sampled values to the time base calculator,
wherein the time base calculator selects the sampled values being obtained by sampling a signal of which slew rate is high, thereby obtaining the time base information.

5. The sampling device according to claim 3, wherein the phase adjusting circuit generates the second reference signal of which phase is in quadrature to that of the first reference signal.

6. The sampling device according to claim 4, wherein the phase adjusting circuit generates the second reference signal of which phase is in quadrature to that of the first reference signal.

7. The sampling device according to claim 2, wherein the first frequency converting circuit is a frequency synthesizer that uses a phase-locked loop.

8. The sampling device according to claim 2, wherein the first frequency converting circuit generates the first strobe signal with a variable frequency.

9. A sampling method for repetitive sampling a measured signal and reproducing a waveform of the measured signal, the sampling method comprising:
generating a reference signal having a predetermined frequency;
generating a strobe signal from a clock signal being synchronized with the measured signal;
sampling the measured signal and the reference signal by using the strobe signal respectively;
obtaining time base information of the measured signal on the basis of a sampling result of the reference signal; and
reproducing the waveform of the measured signal on the basis of the obtained time base information and a sampling result of the measured signal.
